(19) United States
(12) Patent Application Publication
(10) Pub. No.: US 2020/0080479 A1
(43) Pub. Date: Mar. 12, 2020

(54) ICE SEPARATOR OF A FUEL SYSTEM FOR A GAS TURBINE ENGINE

(71) Applicant: PRATT & WHITNEY CANADA CORP., Longueuil (CA)

(72) Inventors: Ignazio BROCCOLINI, Montreal (CA); Hytham MOKHTAR, Pointe-Claire (CA)

(21) Appl. No.: 16/125,874

(22) Filed: Sep. 10, 2018

(51) Int. Cl. F02C 7/22; F01D 25/02; B01D 39/12; B01D 21/00

(52) U.S. Cl. CPC F02C 7/222; F01D 25/02; F05D 2220/323; B01D 21/0042; B01D 21/0012; B01D 39/12

(57) ABSTRACT

An ice separator of a fuel system for a gas turbine engine is provided. The ice separator comprises an inlet duct extending along an inlet direction and an outlet duct. The inlet duct branching off into a first branch duct and a second branch duct. The first and second branch ducts merging into the outlet duct. The first branch duct having at least a portion aligned with the inlet direction and the second branch duct extending away from the inlet direction upwardly toward the outlet duct, and a strainer disposed across the first branch duct.

### TECHNICAL FIELD

The application relates generally to a fuel system of a gas turbine or other aircraft engine and, more particularly, to an ice separator of the fuel system.

### BACKGROUND OF THE ART

Fuel tanks of an aircraft may supply a gas turbine or other type of aircraft engine with fuel. In general, there may be a certain amount of water present in the fuel. Under certain conditions, such as transient ice conditions, the water may freeze and form ice particles within the fuel tanks and/or the fuel feed system of the aircraft. The ice particles may dislodge and flow with the fuel into the fuel system of the gas turbine engine. However, the ice particles can block the fuel flow within the fuel system. For example, if the ice particles exceed a certain amount and/or if the ice particles are of a certain size. In some operations, the engine may shut down in flight if the ice particles block the fuel flow in the fuel system.

### SUMMARY

In one aspect, there is provided an ice separator of a fuel system for an aircraft engine, the ice separator comprising an inlet duct extending along an inlet direction and an outlet duct, the inlet duct branching off into a first branch duct and a second branch duct, the first and second branch ducts merging into the outlet duct, the first branch duct having at least a portion aligned with the inlet direction and the second branch duct extending away from the inlet direction upwardly toward the outlet duct; and a strainer disposed across the first branch duct.

In another aspect, there is provided a gas turbine engine extending along a longitudinal axis, the gas turbine engine comprising a pump; an ice separator in fluid communication with the pump, the ice separator having an inlet duct, an outlet duct, and first and second branch ducts connecting the inlet duct to the outlet duct, the first branch duct having at least a portion aligned with the inlet duct, the second branch duct extending toward the outlet duct transversely relative to the inlet duct and upwardly relative to the longitudinal axis of the gas turbine engine; and a strainer disposed across the first branch duct.

In a further aspect, there is provided a method for delivering fuel to a gas turbine engine, the method comprising flowing fuel in an inlet duct of an ice separator; separating ice particles contained within the fuel and directing said ice particles in a first flow of the fuel through a first path from the inlet duct to an outlet duct; directing a second flow of the fuel through a second path from the inlet duct to the outlet duct; and straining the first flow to block the ice particles from reaching the outlet duct.

### DESCRIPTION OF THE DRAWINGS

Reference is now made to the accompanying figures in which:

FIG. 1 is a schematic cross-sectional view of a gas turbine engine;

FIG. 2 is a schematic view of an ice separator mounted to the gas turbine engine of FIG. 1;

FIG. 3 is a schematic view of a fuel system;

FIG. 4A is a cross-sectional view of the ice separator of FIG. 2;

FIG. 4B is a front view of a strainer of the ice separator of FIG. 4A; and

FIG. 4C is a view of the ice separator of FIG. 4A shown in an angled orientation relative to a longitudinal axis of the gas turbine engine of FIG. 1.

### DETAILED DESCRIPTION

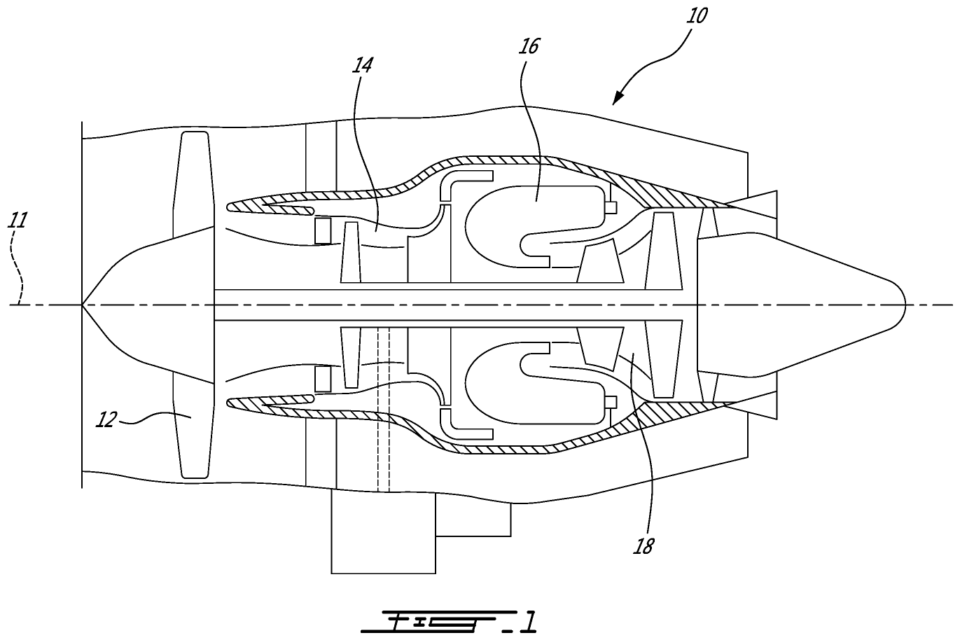

FIG. 1 illustrates an example of a gas turbine engine 10 of a type preferably provided for use in subsonic flight, generally comprising in serial flow communication along a longitudinal axis 11 a fan 12 through which ambient air is propelled, a compressor section 14 for pressurizing the air, a combustor 16 in which the compressed air is mixed with fuel and ignited for generating an annular stream of hot combustion gases, and a turbine section 18 for extracting energy from the combustion gases. The skilled reader will appreciate that the present description has application to any aircraft engine fuel system susceptible to icing.

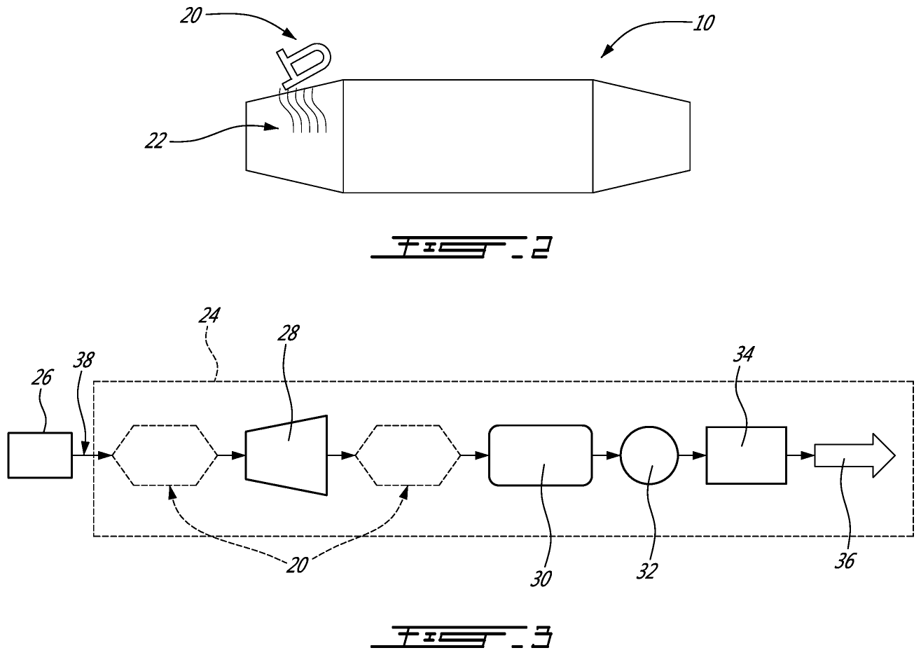

Referring to FIG. 2, a schematic view of a particle separator 20 mounted to the gas turbine engine 10 is shown. The particle separator 20 may be used to separate particles from the fuel. The particle separator 20 can be used on different engine types, such as a turboshaft, a turbofan, and a turboprop. The particles may refer to any solid materials that are generally denser than liquid fuel. For example, the particles may include ice that may be formed from water present in the fuel supplied to the gas turbine engine 10. The particles may also include other materials which are more dense than fuel and have the potential to be captured by the ice separator 20, such as foreign particle contamination. In other words, the particles may sink when placed in the fuel. The particle separator 20 may be referred to as an “ice separator” when the particle separator 20 is mainly used to obstruct the passage of the ice particles. In operation, the ice separator 20 generally separates and contains the ice particles that may be present in the fuel for supplying fuel free of ice particles to at least some components of the gas turbine engine 10, such as fuel filters, fuel heaters, or both. In the embodiment shown in FIG. 2, the ice separator 20 is mounted in proximity of a heat source 22 for melting the ice particles that may form within the fuel. The heat source 22 may include components of the gas turbine engine 10 that may generate residual heat when the gas turbine engine 10 is shutdown to melt the ice particles. Sources of residual heat may include hot oil in an accessory gearbox and/or reduction gearbox of the engine. Other sources include a gas generator section of the engine such as a combustor and turbine sections.

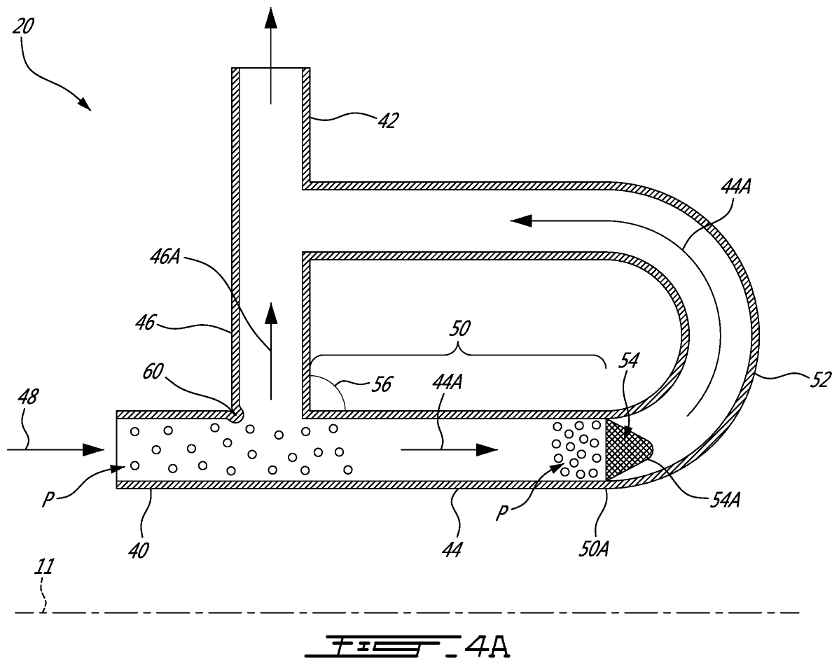

Referring to FIG. 3, a schematic view of a fuel system 24 of the gas turbine engine 10, or part of a fuel system, is shown. The fuel system 24 may refer to any one or more components providing a flow of the fuel from a fuel tank 26 of an aircraft to the combustor 16. In some embodiments, the fuel system 24 may include a pump 28 to pump the fuel from the fuel tank 26. For example, the pump 28 may be a low pressure pump. The fuel system 24 may include a fuel heater 30 such as a fuel-to-oil heat exchanger, a fuel filter 32, a fuel metering unit 34, and fuel nozzles 36. It is understood that the fuel system 24 may include any of these components 28, 30, 32, 34, 36 or any combination thereof. It should also be understood that these components have been schematically illustrated and that the fuel system 24 may include additional components that are not specifically illustrated in the figures or described herein.

The ice separator 20 may be provided in fluid communication with the pump 28. For example, the ice separator 20 may be provided upstream of the pump 28 or downstream of the pump 28 relative to a fuel flow from the fuel tank 26 to the fuel nozzles 36. The fuel nozzles 36 are intended to refer to nozzles that may supply the fuel into the combustor 16. The ice separator 20 may be provided at any other suitable location upstream of the fuel heater 30 and the fuel filter 32. In some embodiments, the fuel heater 30 and/or the fuel filter 32 may be blocked due to ice accumulation in the fuel if the fuel contains an elevated amount of ice particles therein. The ice separator 20 may form part of the fuel system 24 of the gas turbine engine 10 to block the ice particles from reaching sensitive components of the fuel system 24.

In operation, the formation of ice may occur upstream of the gas turbine engine 10. For example, the ice or ice particles may form in the fuel tank 26 of the aircraft and/or a fuel system of the aircraft, such as a piping 38 connecting the fuel tank 26 to the gas turbine engine 10. As such, the ice separator 20 may be used to obstruct the passage of the ice particles from the fuel tank 26 or the aircraft to the fuel heater 30, the fuel filter 32, or both.

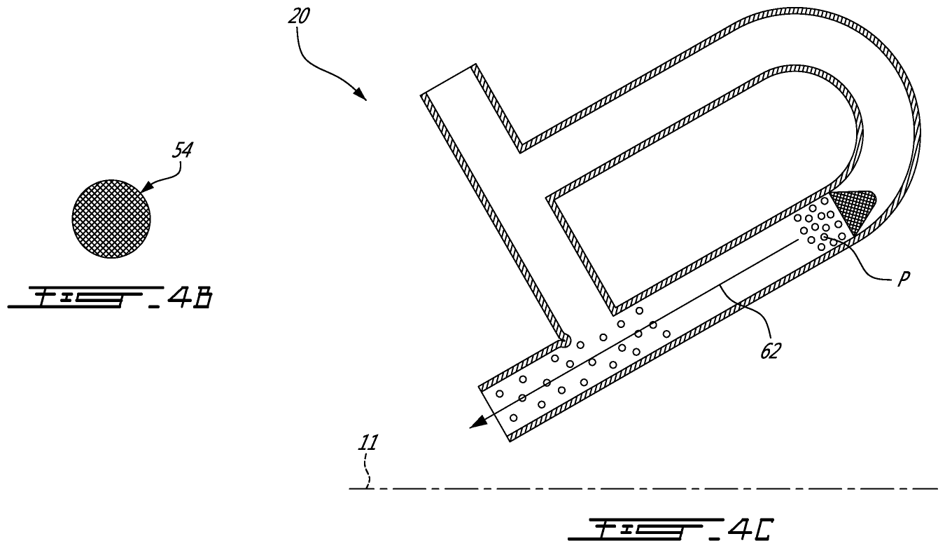

Referring to FIG. 4A, a cross-sectional view of the ice separator 20 is shown. The ice separator 20 may include an inlet duct 40, an outlet duct 42, and first and second branch ducts 44, 46 connecting the inlet duct 40 to the outlet duct 42. In other words, the first and second branch ducts 44, 46 may provide parallel passages for the fuel to flow from the inlet duct 40 to the outlet duct 42. The first branch duct 44 may form a first path 44A for a fuel flow from the inlet duct 40 to the outlet duct 42 and the second branch duct 46 may form a second path 46A separate from the first path 44A for a fuel flow from the inlet duct 40 to the outlet duct 42.

The inlet duct 40 may provide a conduit connecting the ice separator 20 with the fuel source for supplying the ice separator 20 with the fuel. In use, the fuel may be pumped or sucked into the inlet duct 40. In some embodiments, as mentioned above, the inlet duct 40 may be connected to the pump 28 when the ice separator 20 is provided downstream of the pump 28. The outlet duct 42 may be connected to the pump 28 when the ice separator 20 is provided upstream of the pump 28. The inlet duct 40 may extend along an inlet direction 48. In other words, the inlet direction 48 may extend along the longitudinal axis of the inlet duct 40. That is, the fuel and any ice particles P entering the inlet duct 40 may be provided with a momentum at least partially in the inlet direction 48. In other words, the momentum of higher density particles may propel the ice particles P toward the first branch duct 44.

In the example shown in FIG. 4A, the inlet duct 40 branches off into the first branch duct 44 and the second branch duct 46. In other words, the inlet duct 40 splits or subdivides into the first and second branch ducts 44, 46. Thus, the fuel flowing in the inlet duct 40 may then be directed to the first branch duct 44 and/or the second branch duct 46, as will be discussed below. The first and second branch ducts 44, 46 merge into the outlet duct 42. That is, outlets of the first and second branch ducts 44, 46 feed the outlet duct 42. The first branch duct 44 may have a length that is longer than a length of the second branch duct 46. The length may be measured from the inlet duct 40 to the outlet duct 42.

The first branch duct 44 has at least a portion 50 aligned with the inlet direction 48. For example, the portion 50 may be straight or may be slightly curved. The portion 50 may form generally a longitudinal extension of the inlet duct 40. In other words, the term “aligned” may refer to forming a general longitudinal extension. In some embodiments, the portion 50 aligned in straight line with the inlet duct 40 may promote the motion of the more dense ice particles P to continue straight toward the first branch duct 44. The first branch duct 44 may include a bend 52 or a curved portion at an end 50A of the portion 50 aligned with the inlet direction 48. For example, the bend 52 may include a 180 degrees turn.

The ice separator 20 may include a strainer 54 disposed across the first branch duct 44. The strainer 54 is intended to refer to any suitable device for allowing the fuel to pass therethrough while blocking the ice particles P. For example, the strainer 54 may include a screen or a mesh having openings 54A sized to block particles P of a certain size. In use, the strainer 54 may block the ice particles P and collect the ice particles P in the first branch duct 44 upstream of the strainer 54. FIG. 4B illustrates a front view of the strainer 54. The strainer 54 may include a perforated plate disposed across the first branch duct 44. For example, the strainer may include a wire mesh arrangement. The strainer 54 surface may be coated with, or made from, a material which may preclude the formation of new ice resulting from any water that may be present in the fuel. In some embodiments, the strainer 54 may include a body extending along the first branch duct 44 to form a cavity defined by the body. In other words, the strainer 54 may be shaped in “3D” or extends along the first branch duct 44 to maximize a surface area of the strainer 54 and hence maximize a volume of ice which can be collected without completely blocking the openings 54A of the strainer 54. In an event of total blockage of the strainer 54, the fuel flow to the outlet duct 42 may be maintained through the second branch duct 46.

The strainer 54 may be disposed in the portion 50 aligned with the inlet direction 48. The location of the strainer 54 downstream of the intersection between the inlet duct 40 and the second branch duct 46 may be configured to capture a highest volume of ice particles P likely to be ingested by the fuel system 24 of the gas turbine engine 10. As such, the strainer 54 may be positioned to allow more space for storing the ice particles P in the first branch duct 44. In other words, the volume between the second branch duct 46 and the strainer 54 may be varied depending on the location of the strainer 54 within the first branch duct 44. For example, the strainer 54 may be disposed at the end 50A of the portion 50 aligned with the inlet direction 48. The volume of the ice particles P may depend on the type and the size of the aircraft. For example, larger aircrafts may generate more ice particles P.

The second branch duct 46 may extend away from the inlet direction 48 upwardly toward the outlet duct 42. The term “upwardly” is intended to refer to a direction generally opposite to the pull of gravity, such that a body with lower density would move upwardly relative to a body with higher density. In other words, the term “upwardly” may refer to the general orientation with respect to the longitudinal axis 11 of the gas turbine engine 10, as defined in normal use and/or when the engine 10 is shutdown.

The second branch duct 46 may intersect the inlet duct 40 and/or the inlet direction 48 at an angle 56 such that the ice particles P flow from the inlet duct 40 to the first branch duct 44 without entering the second branch duct 46. The angle 56 may be any suitable angle sufficient to differentiate the second branch duct 46 from the first branch duct 44. For example, the second branch duct 46 may intersect the inlet duct 40 at an angle 56 of at least 45 degrees relative to the inlet direction 48. The second branch duct 46 may be perpendicular to the inlet direction 48. In other words, the angle 56 may be 90 degrees relative to the inlet direction 48. The angle 56 may be defined between the inlet direction 48 and a longitudinal axis of the second branch duct 46. In the embodiment shown in FIG. 4A, the angle 56 increases in the counter-clockwise direction from the inlet direction 48. The second branch duct 46 may be straight or generally straight. The term “straight” is intended to refer to a general shape of the second branch duct 46.

In use, the liquid fuel, which is less dense than the ice particles P, may turn toward the second branch duct 46. In other words, the second branch duct 46 may represent a lower resistance path relative to the first branch duct 44. The fuel may thus flow in the second branch duct 46 toward the outlet duct 42.

In use, the fuel and ice particles mixture may enter the ice separator 20 through the inlet duct 40. The ice particles P, which are generally more dense than the fuel, tend to flow or move along the inlet direction 48 from the inlet duct 40 to the portion 50 aligned with the inlet direction 48. In other words, the ice separator 20 utilizes the greater inertia of the ice particles P relative to the fuel to direct the ice particles P into the first branch duct 44. As such, the ice particles P flow toward the strainer 54. The strainer 54 may collect the ice particles P that are larger than the openings 54A defined in the body of the strainer 54. The fuel passing through the strainer 54 is thus free of the ice particles P. This “filtered” fuel may then mix with the fuel flowing through the second branch duct 46 in the outlet duct 42.

The ice separator 20 may include a deflector 60 configured to direct and/or deflect the ice particles P away from the second branch duct 46 and toward the first branch duct 44. The deflector 60 may be a baffle. The deflector 60 may be any suitable protrusion extending in the inlet duct 40, the first branch duct 44, the second branch duct 46, or any combination of these ducts 40, 42, 46. The deflector 60 may be provided upstream of the second branch duct 46 relative to the fuel flow along the inlet direction 48. The deflector 60 may be located at the intersection or junction between the inlet duct 40 and the second branch duct 46. The deflector 60 may be located at the intersection or junction between the inlet duct 40 and the first branch duct 44.

Referring to FIG. 4C, the ice separator 20 is shown in an orientation relative to the longitudinal axis 11. In other words, the inlet duct 40 may be oriented transversally upward relative to the longitudinal axis 11. The term “transversally” is intended to refer to an inclination relative to the longitudinal axis 11. In use, this orientation may allow the ice particles P to sink toward the heat source 22 to melt the ice particles P. That is, the inclination may allow the ice particles P to sink from the first branch duct 44 toward the inlet duct 40 by gravity in a direction 62. The direction 62 may be opposite to the inlet direction 48. In some embodiment, the proximity of the ice separator 20 to the heat source 22 may allow the heat to melt the ice particles P. For example, when the gas turbine engine 10 is shutdown, the residual heat from engine 10 may melt the ice in the fuel. In other words, upon engine shutdown, the ice particles P sink or drain by gravity in the ice separator 20 toward the heat source 22 or the residual heat. The location and orientation of the ice separator 20 may thus be configured to melt the ice particles P upon engine shutdown. The heat source 22 may heat the inlet duct 40 and the first branch duct 44 to melt the ice particles P. The orientation may allow water (melted ice) to sink toward the inlet duct 40 to drain out the water from the ice separator 20.

In some embodiments, there are no moving parts in the ice separator 20 which may increase a reliability of the ice separator 20. In some embodiments, the ice separator 20 may limit a pressure drop of the fuel flowing through the ice separator 20. A large pressure drop may affect the pump's performance and efficiency. For example, the second branch duct 46 would allow fuel flow if the strainer 54 becomes blocked. Thus, fuel pressure drop would not be significantly affected.

The above description is meant to be exemplary only, and one skilled in the art will recognize that changes may be made to the embodiments described without departing from the scope of the invention disclosed. For example, the ice particles may be replaced by other particles. Any suitable engine type may be used. The inlet duct may branch into any number of paths. Still other modifications which fall within the scope of the present invention will be apparent to those skilled in the art, in light of a review of this disclosure, and such modifications are intended to fall within the appended claims.

1. An ice separator of a fuel system for an aircraft engine, the ice separator comprising:
an inlet duct extending along an inlet direction and an outlet duct, the inlet duct branching into a first branch duct and a second branch duct, the first and second branch ducts merging into the outlet duct, the first branch duct having at least a portion aligned with the inlet direction and the second branch duct extending away from the inlet direction upwardly toward the outlet duct; and
a strainer disposed across the first branch duct.

2. The ice separator as defined in claim 1, wherein the second branch duct intersects the inlet direction at an angle of at least 45 degrees relative the inlet direction.

3. The ice separator as defined in claim 1, wherein the second branch duct is perpendicular to the inlet direction.

4. The ice separator as defined in claim 1, wherein the strainer is disposed in the portion aligned with the inlet direction.

5. The ice separator as defined in claim 1, wherein the first branch duct includes a bend at an end of the portion aligned with the inlet direction opposite the inlet duct, the strainer being disposed at said end of the portion aligned with the inlet direction.

6. The ice separator as defined in claim 1, wherein the second branch duct is straight.

7. The ice separator as defined in claim 1, comprising a deflector provided upstream of the second branch duct relative to a fuel flow along the inlet direction, the deflector configured to deflect ice particles away from the second branch duct.

8. The ice separator as defined in claim 1, wherein the strainer has a body extending along the first branch duct to form a cavity defined by said body.

9. A gas turbine engine extending along a longitudinal axis, the gas turbine engine comprising:
a pump;
an ice separator in fluid communication with the pump, the ice separator having an inlet duct, an outlet duct, and first and second branch ducts connecting the inlet duct to the outlet duct, the first branch duct having at least a portion aligned with the inlet duct, the second branch duct extending toward the outlet duct transversely relative to the inlet duct and upwardly relative to the longitudinal axis of the gas turbine engine; and
a strainer disposed across the first branch duct.

10. The gas turbine engine as defined in claim 9, wherein the second branch duct intersects the inlet duct at an angle of at least 45 degrees relative to a longitudinal axis of the inlet duct.

11. The gas turbine engine as defined in claim 9, wherein the second branch duct is perpendicular to the inlet duct.

12. The gas turbine engine as defined in claim 9, wherein the second branch duct is straight.

13. The gas turbine engine as defined in claim 9, wherein the first branch duct has a length longer than a length of the second branch duct from the inlet duct to the outlet duct.

14. The gas turbine engine as defined in claim 9, comprising a deflector provided upstream of the second branch duct relative to a fuel flow along the inlet duct, the deflector configured to deflect ice particles away from the second branch duct and toward the first branch duct.

15. The gas turbine engine as defined in claim 9, wherein the inlet duct is oriented transversally upward relative to the longitudinal axis.

16. The gas turbine engine as defined in claim 9, wherein the strainer has a body extending along the first branch duct to form a cavity defined by said body.

17. A method for delivering fuel to a gas turbine engine, the method comprising:
flowing fuel in an inlet duct of an ice separator;
separating ice particles contained within the fuel and directing said ice particles in a first flow of the fuel through a first path from the inlet duct to an outlet duct;
directing a second flow of the fuel through a second path from the inlet duct to the outlet duct; and
straining the first flow to block the ice particles from reaching the outlet duct.

18. The method as defined in claim 17, comprising deflecting the ice particles toward the first path and away from the second path.

19. The method as defined in claim 17, wherein a momentum of the ice particles flowing in the inlet duct propels the ice particles toward the first path.

20. The method as defined in claim 17, comprising sinking the ice particles toward the inlet duct upon shutting down the gas turbine engine.
